(19) United States
(12) Patent Application Publication
(10) Pub. No.: US 2013/0152016 A1
(43) Pub. Date: Jun. 13, 2013

(54) USER INTERFACE AND METHOD FOR PROVIDING SAME

(71) Applicant: Jean-Baptiste MARTINOLI, St-Anaclet-de-Lessard (CA)

(72) Inventor: Jean-Baptiste MARTINOLI, St-Anaclet-de-Lessard (CA)

(21) Appl. No.: 13/538,587

(22) Filed: Jun. 29, 2012

Related U.S. Application Data
(60) Provisional application No. 61/568,510, filed on Dec. 8, 2011.

(51) Int. Cl. G06F 3/041; G06F 3/048

(52) U.S. Cl. 715/810

(57) ABSTRACT

A method for providing a user interface on a touch screen display, the user interface for performing one of executing an application, accessing a file and accessing a weblink, the method comprising displaying an icon on the touch screen display; detecting an interaction with the icon displayed, said interaction being performed by a hand of a user; displaying a plurality of icons on the touch screen display, each icon of the plurality of icons for performing one of executing an application, accessing a file and accessing a weblink, the plurality of icons forming a portion of a circle substantially centered on the hand such that each icon is accessible with a minimum displacement of a finger of an open hand of the user.

### CROSS-REFERENCE TO RELATED APPLICATIONS

The patent application claims priority of U.S. Provisional patent application No. 61/568,510, entitled “User interface and method for providing same”, that was filed on Dec. 8, 2011, the specification of which is hereby incorporated by reference.

### FIELD OF THE INVENTION

The invention relates to the field of computing devices. More precisely, this invention pertains to a user interface for a touch sensitive display and to a method for providing same.

### BACKGROUND

Being able to interact efficiently with a touch sensitive display, also referred to as a touch screen display, is key for ensuring an enjoyable experience with a touch screen display.

In fact, while in computers having non touch screen displays, such as desktop computers with standard displays, the user may interact with the computer using a keyboard and a mouse for instance, with touch screen displays user interfaces may be designed and implemented depending on various considerations.

For instance and in one embodiment, a plurality of icons may be displayed evenly on the touch screen display at various positions on the surface of the touch screen display. In such embodiment, the user will interact with the computer by touching the touch screen display at a position where a given icon is located, causing for instance an application associated with the given icon to be executed.

Unfortunately interacting with such embodiment of a user interface is quite cumbersome for the user since it will require the user to make a movement of the arm and then possibly a movement of a finger to execute the application. This may require a lot of effort from the user in the case where the touch screen display is a large touch screen display and also in the case where repetitive interactions are required. The consequence of the drawback associated with the user interface will be amplified when the user is a senior citizen.

There is a need for a user interface and a method for providing same that will overcome at least one of the above-identified drawbacks.

Features of the invention will be apparent from review of the disclosure, drawings and description of the invention below.

### BRIEF SUMMARY

According to a broad aspect of the invention, there is disclosed a method for providing a user interface on a touch screen display, the user interface for performing one of executing an application, accessing a file and accessing a we blink, the method comprising displaying an icon on the touch screen display; detecting an interaction with the icon displayed, said interaction being performed by a hand of a user; displaying a plurality of icons on the touch screen display, each icon of the plurality of icons for performing one of executing an application, accessing a file and accessing a weblink, the plurality of icons forming a portion of a circle substantially centered on the hand such that each icon is accessible with a minimum displacement of a finger of an open hand of the user.

In accordance with one embodiment, the icon displayed on the touch screen display has a shape of one of a circle, a square and a polygon.

In accordance with an embodiment, the icon is displayed on the touch screen display for a given amount of time.

In accordance with an embodiment, the detecting of an interaction with the icon displayed comprises detecting a drag movement of a finger of the user and changing the display of the icon displayed in accordance with the drag movement.

In accordance with an embodiment, the detecting of an interaction with the icon displayed comprises detecting one of a simple click and a double click by a finger of a user on the icon displayed.

In accordance with an embodiment, the detecting of an interaction with the icon displayed comprises detecting an interaction of a closed hand and detecting a motion of the fingers of the closed hand.

In accordance with an embodiment, the motion of the fingers of the closed hand comprises opening the closed hand.

In accordance with an embodiment, the method further comprises displaying a second group of icons around the plurality of icons such that the second group of icons surrounds the plurality of icons and forms a portion of a circle substantially centered on the hand such that each icon of the second group of icon is accessible with a minimum displacement of a finger of an open hand of the user.

In accordance with an embodiment, the second group of icons is displayed following an interaction of a user with an icon of the plurality of icons.

In accordance with an embodiment, each icon of the second group of icons is for performing one of executing an application, accessing a file and accessing a weblink.

In accordance with an embodiment, the circle has a radius which depends on a size of a hand.

In accordance with an embodiment, each of the plurality of icons comprises a graphics.

In accordance with an embodiment, the method further comprises detecting an interaction of a finger of a user on a given icon of the plurality of icons and performing one of executing an application associated with the given icon, accessing a file associated with the given icon and accessing a weblink associated with the given icon.

In accordance with an embodiment of the invention, there is disclosed a computer-readable storage medium storing computer-executable instructions which, when executed, cause a computing device to perform a method for generating a user interface on a touch screen display, the user interface for performing one of executing an application, accessing a file and accessing a weblink, the method comprising displaying an icon on the touch screen display; detecting an interaction with the icon displayed, said interaction being performed by a hand of a user; displaying a plurality of icons on the touch screen display, each icon of the plurality of icons for performing one of executing an application, accessing a file and accessing a weblink, the plurality of icons forming a portion of a circle substantially centered on the hand such that each icon is accessible with a minimum displacement of a finger of an open hand of the user.

In accordance with one aspect of the invention, there is disclosed a computing device, the computing device comprising a touch screen display; a central processing unit; a memory comprising one or more programs, wherein the one or more programs are stored in the memory and configured to be executed by the central processing unit, the one or more programs including instructions for displaying an icon on the touch screen display; instructions for detecting an interaction with the icon displayed, said interaction being performed by a hand of a user; instructions for displaying a plurality of icons on the touch screen display, each icon of the plurality of icons for performing one of executing an application, accessing a file and accessing a weblink, the plurality of icons forming a portion of a circle substantially centered on the hand such that each icon is accessible with a minimum displacement of a finger of an open hand of the user.

### BRIEF DESCRIPTION OF THE DRAWINGS

In order that the invention may be readily understood, embodiments of the invention are illustrated by way of example in the accompanying drawings.

FIG. 1 is a flowchart which shows an embodiment of a method for providing a user interface on a touch screen display; according to a first processing step an icon is displayed on the touch screen display; according to a second processing step an interaction with the icon is detected and according to a third processing step a plurality of icons are displayed.

FIG. 2 is a flowchart which shows how the interaction with the icon is performed in accordance with an alternative embodiment.

FIG. 3 is a schematic which shows an embodiment of a user interface displayed on the touch screen display.

FIG. 4 is a schematic which shows an embodiment of a user interface displayed on the touch screen display during an interaction with the main icon.

FIG. 5 is a screenshot which shows an embodiment of a user interface displayed on the touch screen display following an interaction with the main icon.

FIG. 6 is a block diagram which shows an apparatus in which an embodiment of the method for providing a user interface on a touch screen display may be implemented.

FIG. 7a is a screenshot which shows an embodiment of a user interface displayed on the touch screen display during an interaction with the icon.

FIG. 7b is a screenshot which shows an embodiment of a user interface displayed on the touch screen display following an interaction with the icon.

Further details of the invention and its advantages will be apparent from the detailed description included below.

### DETAILED DESCRIPTION

In the following description of the embodiments, references to the accompanying drawings are by way of illustration of an example by which the invention may be practiced. It will be understood that other embodiments may be made without departing from the scope of the invention disclosed.

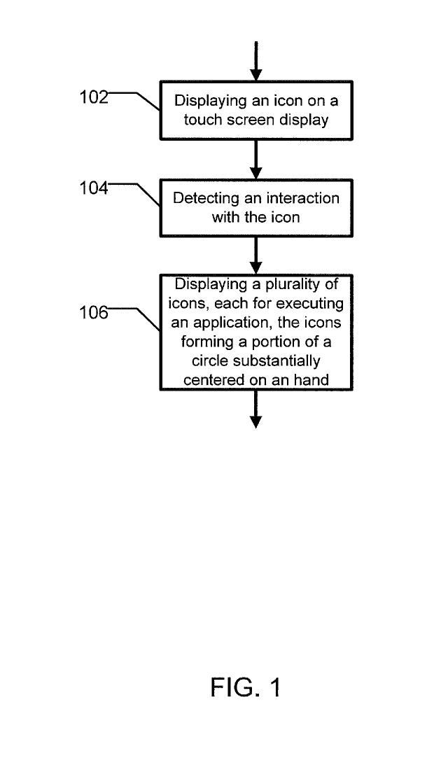

Now referring to FIG. 1, there is shown an embodiment of a method for providing a user interface on a touch screen display. It will be appreciated that the user interface may be used for performing one of executing an application, accessing a file and accessing a web link.

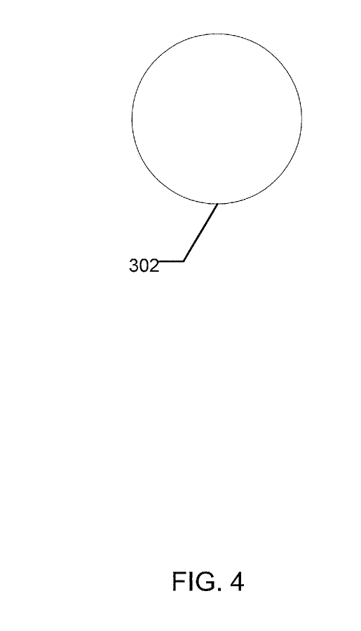

According to processing step 102, an icon is displayed on the touch screen display. This icon will be referred to as a main icon in the following. An example of such main icon is shown in FIG. 4.

In this preferred embodiment, the main icon has a shape of a circle.

The skilled addressee will however appreciate that various alternative embodiments may be possible for the main icon. In particular, the main icon may have the shape of a square, a polygon, or the like.

In a preferred embodiment, the main icon remains accessible at all time. In an alternative embodiment such as for instance in the case of immersive applications such as games, the main icon may be hidden temporarily. In this embodiment, the applications will be provided with means for displaying the main icon back on the touch screen display.

Moreover, it will be appreciated that the main icon may be moved from one location of the touch screen display to another location of the touch screen display using a drag movement of a finger. The skilled addressee will appreciate that various alternative embodiments may be provided for moving the main icon from one location of the touch screen to the other location of the touch screen display.

It will be appreciated that in a preferred embodiment, the main icon is used for enabling a control of the display of the user interface.

According to processing step 104, an interaction is detected with the main icon displayed. It will be appreciated that the interaction is performed by a hand of the user in one embodiment.

In a preferred embodiment, the interaction with the main icon comprises one click by a finger of the hand of a user on the main icon.

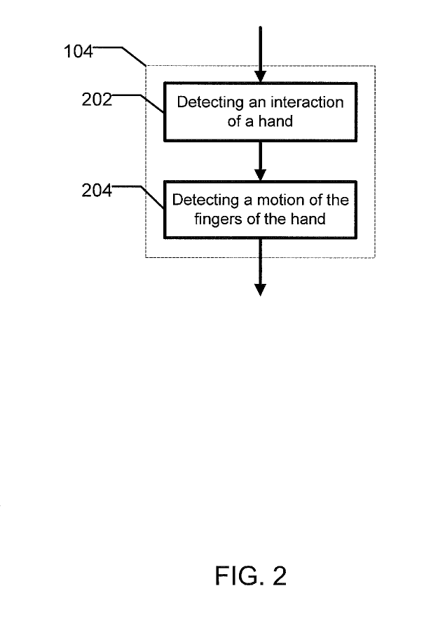

Now referring to FIG. 2, there is shown an alternative embodiment of a method for detecting an interaction with the main icon on the touch screen display. In this embodiment, the hand is firstly closed.

According to processing step 202, an interaction of a hand with the touch screen display is detected.

According to processing step 204, a motion of the fingers of the closed hand is detected.

In this alternative embodiment, the motion of the fingers of the closed hand detected comprises a motion of the fingers, the motion of the fingers being associated with the opening of the hand on the touch screen display. The opening of the hand may be detected using a camera.

Now referring back to FIG. 1 and according to processing step 106, a plurality of icons is displayed on the touch screen display.

In a preferred embodiment, it will be appreciated that each icon of the plurality of icons displayed is used for performing one of executing an application, accessing a file and accessing a web link. It will be appreciated that optionally the main icon may further be displayed together with the plurality of icons. The skilled addressee will appreciate that the main icon may be displayed for enabling a user to readily position the palm of its hand on the user interface. In it will be appreciated that the palm of its hand may be positioned over the main icon in one embodiment.

Moreover and in a preferred embodiment of the user interface displayed, the icons of the plurality of icons form a portion of a circle substantially centered on the hand such that each icon of the plurality of icons is accessible with a minimum displacement of a finger of an open hand of the user.

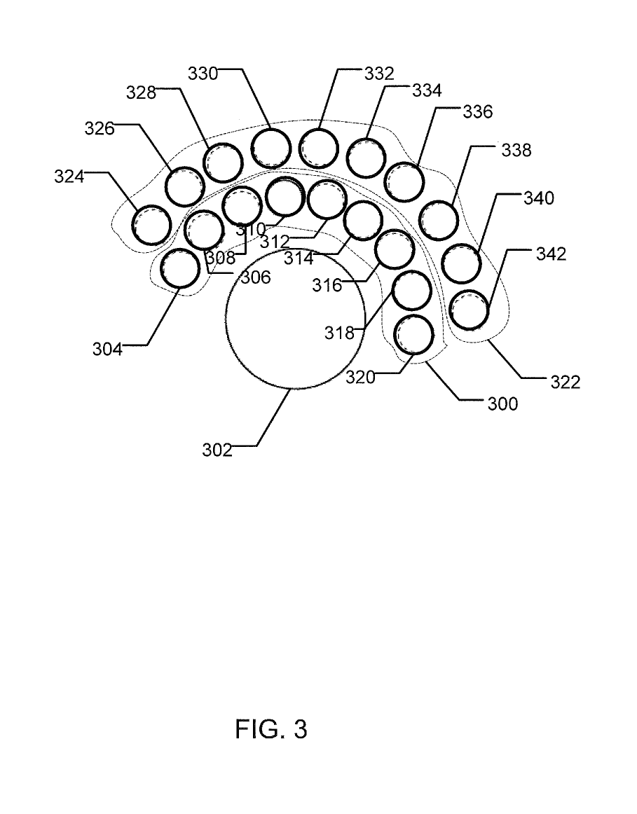

Now referring to FIG. 3, there is shown an embodiment of a user interface displayed.

The user interface comprises a main icon 302, a first group of icons 300 and a second group of icons 322. It will be appreciated that the second group of icons 322 is optional. As mentioned above, it will be further appreciated that the displaying of the main icon 302 is also optional.

As mentioned above, upon interaction with the main icon 302, the first group of icons 300 and the second group of icon 322 are displayed.

Still referring to FIG. 3, the first group of icons 300 comprises icon 304, icon 306, icon 308, icon 310, icon 312, icon 314, icon 316, icon 318 and icon 320.

In a preferred embodiment, the first group of icons 300 comprises nine icons.

It will be appreciated that each icon of the first group of icons 300 is used for performing one of executing an application, accessing a file and accessing a web link.

The second group of icons 322 comprises icon 324, icon 326, con 328, icon 330, icon 332, icon 334, icon 336, icon 338, icon 340 and 342.

In a preferred embodiment the second group of icons 322 comprises ten icons.

It will be appreciated that each icon of the second group of icons 322 is used for performing one of executing an application, accessing a file and accessing a web link.

Moreover, it will be appreciated that an additional group of icons, not shown, may be further displayed and may surround the second group of icons 322.

It will be appreciated that the second group of icons 322 may be placed concurrently to the first group of icons 300. In an alternative embodiment, the second group of icons 322 is displayed following interaction with an icon of the first group of icons 300. For instance and in this embodiment, the second group of icons 322 may comprise a plurality of icons, each for providing an access to a respective web link. The second group of icons may have been displayed following a user clicking on an icon of the first group of icons 300, the icons being associated with a web browser.

As mentioned above and in the embodiment where the first icon 302 is displayed, it will be appreciated that the palm of the hand of the user may be placed above the first icon 302.

It will be further appreciated that the icons of the first group of icons 300 form a portion of a circle substantially centered on the hand, not shown, such that each icon of the first group of icons 300 is accessible with a minimum displacement of a finger of an open hand of the user.

In an alternative embodiment, the parameters of the portion of circle are dependant from the size of the hand of a user and may be dynamically determined. The size of the hand of a user may be determined using the interactions with the touch screen display in an embodiment. Alternatively, the size of the hand of a user may be determined using a camera.

Similarly, each icon of the second group of icons 322 forms a portion of a circle substantially centered on the hand, not shown, such that each icon of the second group of icons 322 is accessible with a minimum displacement of a finger of an open hand of the user which is of great advantage.

In a preferred embodiment, each icon of the first group of icons 300 and the second group of icons 322 has a circular shape. The skilled addressee will appreciate that various alternative embodiments may be possible.

Still in a preferred embodiment, it will be appreciated that each icon of the first group of icons 300 and the second group of icons 322 comprises a graphics representative of an application it is associated to, a type of file it is associated to or a web link it is associated to depending on the case.

The main icon 302 may be used for providing an indication to a user as to where the user should put the palm of its hand on the user interface.

The main icon 302 may also used for displaying the first group of icons 300 and the second group of icons 322 in a preferred embodiment.

As explained above, the displaying may be performed following an interaction of the user with the main icon 302.

The skilled addressee will appreciate that the user interface described above may be moved using a movement of the hand of the user on the touch-screen display.

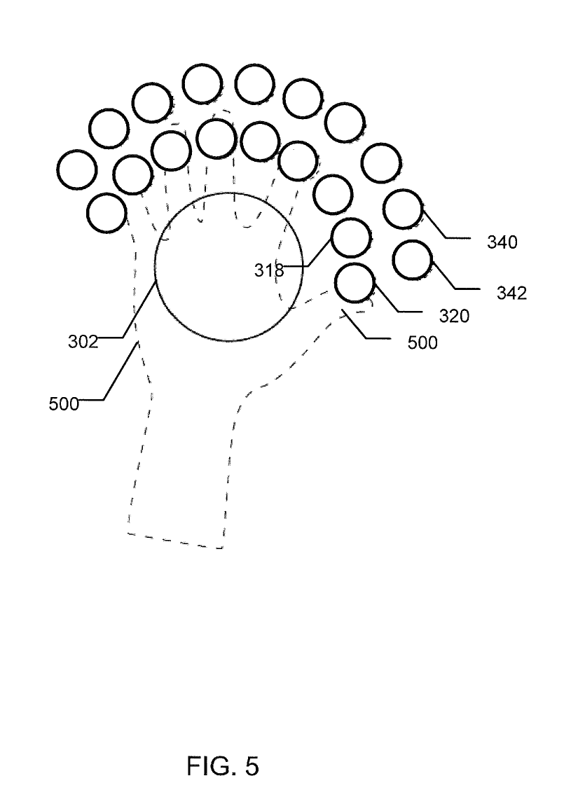

Now referring to FIG. 5, there is shown an embodiment of the user interface disclosed above on which the hand 500 of the user is shown.

The hand 500 comprises a plurality of fingers, one of which is the thumb 502. It will be appreciated that the thumb 502 may be used for instance for clicking on icon 320, on icon 318, on icon 340 and on icon 342. The skilled addressee will appreciate that this may be performed with a minimum effort which is of great advantage. The skilled addressee will also appreciate that all the other fingers of the hand 500 may be advantageously used for clicking on a plurality of icons which is of great advantage.

With a minimum effort, the user may have access to various icons and de facto to various applications which is of great advantage especially on a large display.

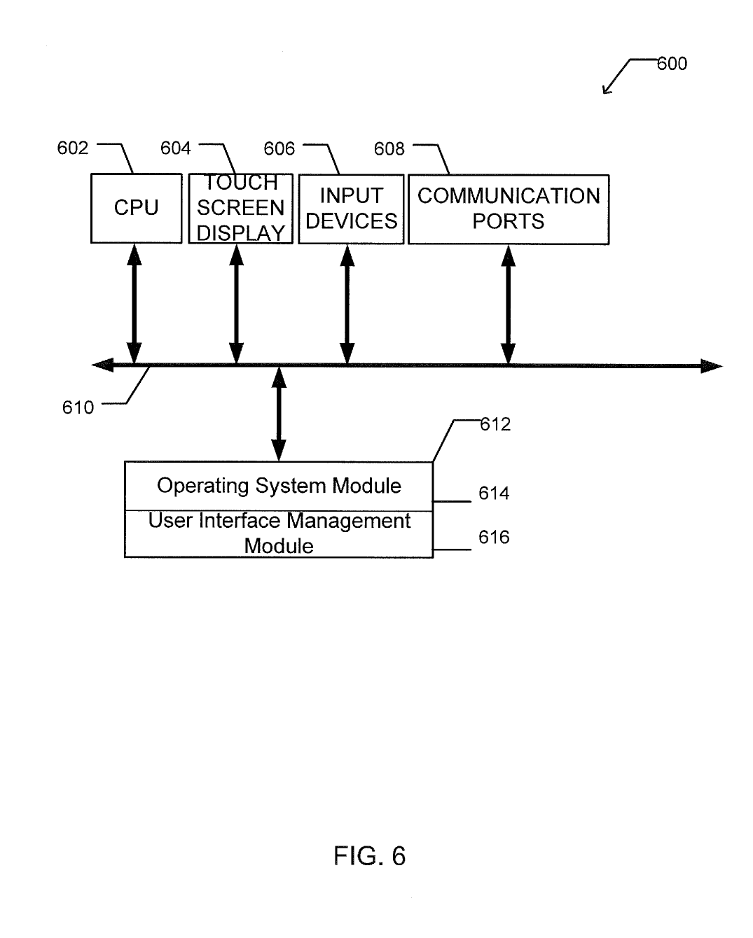

Now referring to FIG. 6, there is shown an apparatus 600 in which an embodiment of the method for providing a user interface may be implemented.

In this embodiment the apparatus 600 comprises a Central Processing Unit (CPU) 602, a touch screen display 604, input devices 606, communication ports 608, a data bus 610 and a memory 612.

The Central Processing Unit 602, the touch screen display 604, the input devices 606, the communication ports 608 and the memory 612 are connected together using the data bus 610.

In a preferred embodiment the apparatus 600 is a custom made PC based on standard Microsoft™ Windows™ 7 Home Premium Edition specifications. Still in this embodiment the Central Processing Unit 602 is i7 which is manufactured by Intel™, running at 3.0 Gz and which supports 64 bits.

Still in this embodiment, the touch screen display 604 comprises a touch sensor panel having a diagonal screen size of 32 inches and a resolution of 1920×1080 pixels. In fact, it will be appreciated that the embodiment disclosed herein may operate with screen sizes larger than 24 inches in one embodiment. The touch sensor panel uses a multipoint capacitive technology known to the ones skilled in the art. The touch sensor panel is operatively connected to a corresponding controller not shown using an RS 232 port or a universal serial bus (USB) port. In a preferred embodiment, the touch sensor panel is a 3M™ projected capacitive having a diagonal screen size of 32 inches and 40 points of touch. It is based on the technology of the 3M™ C3266PW chassis. The touch screen display 604 further comprises a display screen placed below the touch sensor panel. The display screen has a diagonal screen size of 32 inches. The display screen is operatively connected to a corresponding controller, not shown, via a DVI connector or an HDMI connector. The skilled addressee will appreciate that for sake of clarity the touch screen display 112 controllers have not been shown. It will be appreciated that a GMA graphics card manufactured by Intel™ is used for the touch screen display 604. The skilled addressee will appreciate that various alternative embodiments may be possible.

The input devices 606 are used for providing data to the apparatus 600.

The communications ports 608 are used for enabling a communication of the apparatus 600 with other devices.

In a preferred embodiment, the communication ports 608 comprise a WIFI 802.11 b/g/n port, a Bluetooth 2.1+EDR port, two USB 2.0 ports, a SD/SDHC card reader and a mini HDMI port. The skilled addressee will again appreciate that various other embodiments may be provided for the communication ports 608.

The memory 612 is used for storing data.

In this embodiment, the memory 612 comprises DDR3 and has a size of 4GB.

More precisely and still in this embodiment, the memory 612 comprises, inter alia, an operating system module 614. The operating system module 614 is Windows 7™ Home Premium Edition manufactured by Microsoft™.

The memory 612 further comprises a user interface management module 616. The user interface management module 616 is used for managing the user interface of the apparatus 600.

It will be appreciated that the method for providing a user interface may be implemented within the user interface management 616.

In such embodiment, the user interface management 616 comprises instructions for displaying an icon on the touch screen display.

The user interface display 616 further comprises instructions for detecting an interaction with the main icon displayed, the interaction being performed by a hand of a user.

The user interface display 116 further comprises instructions for displaying a plurality of icons on the touch screen display, each icon for performing one of executing an application, accessing a file and accessing a web link, the icons forming a portion of a circle substantially centered on the hand such that each icon is accessible with a minimum displacement of a finger of an open hand of the user.

It will be appreciated by the skilled addressee that alternative embodiments may be possible. For instance, the method for providing a user interface may be implemented within the operating system module 614.

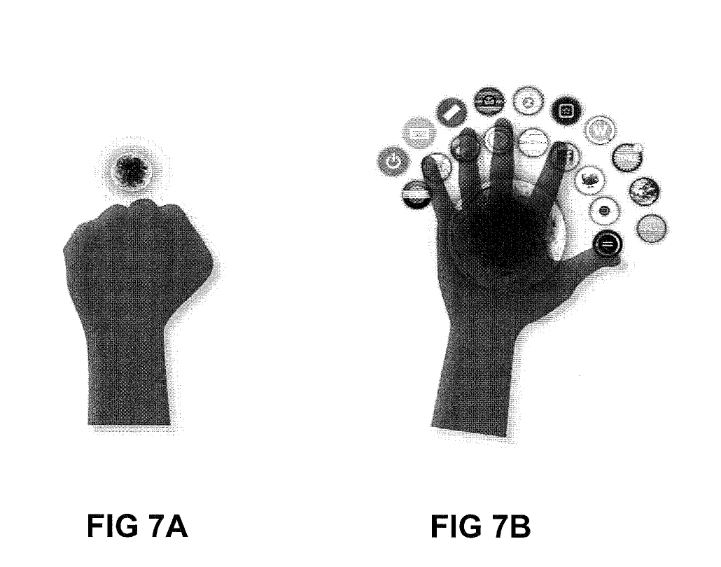

Now referring to FIG. 7a and FIG. 7b, there are shown some screenshots of the user interface respectively during the interaction with the icon and after the interaction with the icon.

The skilled addressee will appreciate that the method disclosed herein is of great advantage since a user may perform one of executing an application, accessing a file and accessing a web link with a limited movement of a corresponding finger of a hand after an interaction has occurred with the user interface.

The skilled addressee will further appreciate that the user interface disclosed herein is of great advantage since the user does not have to move his/her entire hand to a given location of the touch screen to perform one of executing an application, accessing a file and accessing a web link since the user interface can be displayed at any location of the touch screen display and the user may then use a single finger to perform one of executing an application, accessing a file and accessing a web link which is particularly advantageous in the case of large touch screen displays.

It will be appreciated that there a computer-readable storage medium may be provided for storing computer-executable instructions which, when executed, cause a computing device to perform a method for generating a user interface on a touch screen display, the user interface for performing one of executing an application, accessing a file and accessing a web link, the method comprising displaying an icon on the touch screen display; detecting an interaction with the icon displayed, said interaction being performed by a hand of a user; and displaying a plurality of icons on the touch screen display, each icon of the plurality of icons for performing one of executing an application, accessing a file and accessing a web link, the plurality of icons forming a portion of a circle substantially centered on the hand such that each icon is accessible with a minimum displacement of a finger of an open hand of the user.

Although the above description relates to a specific preferred embodiment as presently contemplated by the inventor, it will be understood that the invention in its broad aspect includes mechanical and functional equivalents of the elements described herein.

1. A method for providing a user interface on a touch screen display, the user interface for performing one of executing an application, accessing a file and accessing a weblink, the method comprising:
displaying an icon on the touch screen display;
detecting an interaction with the icon displayed, said interaction being performed by a hand of a user;
displaying a plurality of icons on the touch screen display, each icon of the plurality of icons for performing one of executing an application, accessing a file and accessing a weblink, the plurality of icons forming a portion of a circle substantially centered on the hand such that each icon is accessible with a minimum displacement of a finger of an open hand of the user.

2. The method as claimed in claim 1, wherein the icon displayed on the touch screen display has a shape of a circle, a square and a polygon.

3. The method as claimed in claim 1, wherein the icon is displayed on the touch screen display for a given amount of time.

4. The method as claimed in claim 1, wherein the detecting of an interaction with the icon displayed comprises detecting a drag movement of a finger of the user and changing the display of the icon displayed in accordance with the drag movement.

5. The method as claimed in claim 1, wherein the detecting of an interaction with the icon displayed comprises detecting one of a simple click and a double click by a finger of a user on the icon displayed.

6. The method as claimed in claim 1, wherein the detecting of an interaction with the icon displayed comprises detecting an interaction of a closed hand and detecting a motion of the fingers of the closed hand.

7. The method as claimed in claim 6, wherein the motion of the fingers of the closed hand comprises opening the closed hand.

8. The method as claimed in claim 1, further comprising displaying a second group of icons around the plurality of icons such that the second group of icons surrounds the plurality of icons and forms a portion of a circle substantially centered on the hand such that each icon of the second group of icon is accessible with a minimum displacement of a finger of an open hand of the user.

9. The method as claimed in claim 8, wherein the second group of icons is displayed following an interaction of a user with an icon of the plurality of icons.

10. The method as claimed in claim 8, wherein each icon of the second group of icons is for performing one of executing an application, accessing a file and accessing a weblink.

11. The method as claimed in claim 1, wherein the circle has a radius which depends on a size of a hand.

12. The method as claimed in claim 1, wherein each of the plurality of icons comprises a graphics.

13. The method as claimed in claim 1, further comprising detecting an interaction of a finger of a user on a given icon of the plurality of icons and performing one of executing an application associated with the given icon, accessing a file associated with the given icon and accessing a weblink associated with the given icon.

14. A computer-readable storage medium storing computer-executable instructions which, when executed, cause a computing device to perform a method for generating a user interface on a touch screen display, the user interface for performing one of executing an application, accessing a file and accessing a weblink, the method comprising:
displaying an icon on the touch screen display;
detecting an interaction with the icon displayed, said interaction being performed by a hand of a user;
displaying a plurality of icons on the touch screen display, each icon of the plurality of icons for performing one of executing an application, accessing a file and accessing a weblink, the plurality of icons forming a portion of a circle substantially centered on the hand such that each icon is accessible with a minimum displacement of a finger of an open hand of the user.

15. A computing device, the computing device comprising:
a touch screen display;
a central processing unit;
a memory comprising one or more programs, wherein the one or more programs are stored in the memory and configured to be executed by the central processing unit, the one or more programs including:
instructions for displaying an icon on the touch screen display;
instructions for detecting an interaction with the icon displayed, said interaction being performed by a hand of a user;
instructions for displaying a plurality of icons on the touch screen display, each icon of the plurality of icons for performing one of executing an application, accessing a file and accessing a weblink, the plurality of icons forming a portion of a circle substantially centered on the hand such that each icon is accessible with a minimum displacement of a finger of an open hand of the user.
